(19) United States
(12) Patent Application Publication
(10) Pub. No.: US 2005/0169710 A1
(43) Pub. Date: Aug. 4, 2005

(54) Containment system

(76) Inventor: Joie L. Folkers, Houston, TX (US)

Correspondence Address: CHRISTIE, PARKER & HALE, LLP, PO BOX 7068, PASADENA, CA, 91109-7068, US

(21) Appl. No.: 11/009,319

(22) Filed: Dec. 10, 2004

Related U.S. Application Data
(60) Provisional application No. 60/528,879, filed on Dec. 11, 2003.

(51) Int. Cl. E02B 13/00; B65G 5/00

(52) U.S. Cl. 405/59; 405/53; 405/52

(57) ABSTRACT

A containment system is provided having a primary pipe providing fuel to a fuel dispenser extending above ground level. The primary pipe extends subterraneally. A containment pipe surrounds the primary pipe and defines a containment chamber there between. The containment pipe also extends above ground level and subterraneally.

### CROSS-REFERENCE TO RELATED APPLICATION

This application is based upon and claims priority of U.S. Provisional Application No. 60/528,879, filed on Dec. 11, 2003, the contents of which are fully incorporated herein by reference.

### BACKGROUND OF THE INVENTION

The present invention is directed to a containment system for use in fuel dispensing sites and more specifically to a containment system that does not utilize a sump such as a double wall sump.

In many areas of the United States, state or local regulations require piping which is located underground and conveying hazardous fluids to be secondarily contained. One of the most frequent examples of the application of these regulations is at retail fueling sites, such as gasoline service stations. Gasoline lines connecting Underground Storage Tanks (“UST”) to the gasoline dispensers at service stations are commonly contained in another pipe system.

The gasoline carrying lines for each dispenser are contained within secondary pipes, i.e., containment piping. The gasoline carrying lines or primary lines and the secondary pipes for each dispenser extend from an underground sump at the UST to an underground sump below the dispenser which provides containment under the dispenser and is commonly referred to as an “under dispenser containment sump” or “UDC sump”. The containment piping terminates in the lower portion of the sumps, typically, while the primary pipe connects to piping coupled to the dispenser at one end and to a Submersible Turbine Pump (“STP”) at the other end. In this regard any leakage from the primary line is contained by the corresponding secondary pipe and is relieved into the sump. Fluid sensors are placed at the bottom of the sump to detect the accumulation of fluid such as fuel within the sump.

The sumps are relatively large volume chambers and besides the primary pipes and corresponding secondary pipes they are also penetrated by electrical conduit, and a vapor recovery pipe. A single dispenser sump may have ten or more “penetrations” of various sizes. The interface between the penetrations and the sump are sealed to prevent the contamination of the sump by the environment surrounding the sump including water. Sumps at the UST are typically larger than those under the dispensers and provide a working space for maintenance and repair of the STP and other tank hardware.

Aside from the intended function of containing fuel to keep it from contaminating the surrounding soil, the sump is also expected, and in many jurisdictions, required, to seal against the ingress of ground water. Due to the number of penetrations, the potential for soil movement and the aggressive and corrosive atmosphere inside the sump from fuel vapors, humidity and temperature, failure of a sump and/or the sealing between the penetrations and the sump allowing for the ingress of water into the sum is frequent.

The fluid sensors placed in the bottom of the sumps, are not always designed to distinguish between fuel and water. Consequently, the sensors may provide a false alarm of fuel leakage requiring inspection of the entire fuel dispensing system, when in reality only water has entered the sump.

### SUMMARY OF THE INVENTION

An exemplary containment system is provided that allows for double containment piping to extend to a dispenser in a fuel dispensing site. In an exemplary embodiment, the containment system is not penetrated by other tubings and/or conduits. The exemplary embodiment containment system does away with under dispenser containment sumps.

In another exemplary embodiment a containment system is provided having a primary pipe providing fuel to a fuel dispenser which extends over ground grade level. The primary pipe extends subterraneally. In an exemplary embodiment, the primary pipe is flexible. A containment pipe surrounding the primary pipe and defining a containment chamber there between is also provided. The containment pipe extends above ground grade level and subterraneally.

In another exemplary embodiment, the system further includes a shear valve coupled to the primary pipe. The shear valve may included a break away plane at the ground grade level. The shear valve may also be connected to a bracket coupled to the ground.

In another exemplary embodiment, the system also includes a first pipe section connected to a first end of the primary pipe and a second pipe section connected to a second end of the primary pipe. The primary pipe may include a lip surface at each end which is mated with a lip surface of the first and second pipe sections, respectively. The respective lip surfaces of the primary pipe and each pipe section may be clamped together.

In yet another exemplary embodiment, the system includes a primary riser pipe axially coupled to the primary pipe second end, and a secondary riser pipe surrounding the primary pipe and coupled to the containment pipe defining a riser containment space between the primary and secondary riser pipes which is in communication with the containment chamber. In an exemplary embodiment the diameter of the containment pipe is greater than the diameter of the secondary riser pipe. A containment fitting may be coupled at one end to the containment pipe and at another end to the secondary riser pipe. In a further exemplary embodiment, a spacer is coupled to an outer surface of the secondary riser pipe and an inner surface of the containment fitting.

In another exemplary embodiment, the system includes a primary fitting coupled to the primary riser pipe, and a secondary fitting coupled to the secondary riser pipe such that a fitting annular space is defined between the fittings in communication with the riser containment space. A further pipe section may be coupled to the primary fitting and to an underground storage tank. The secondary fitting may coupled to an outer surface of the further pipe section.

In yet a further exemplary embodiment, the system may include a ring blocking the communication between the fitting annular space and the riser containment space. In one exemplary embodiment, the ring is sandwiched between the secondary riser pipe and the secondary fitting. In another exemplary embodiment, a liquid sensor is located in the riser containment space between the ring and the containment pipe.

In an alternate exemplary embodiment, the containment pipe is made from a non-metallic material such as fiberglass. In another exemplary embodiment, a drip pan may be incorporated in the system extending beyond the containment pipe, such that leakage from the a fuel dispenser is guided by the drip pan to the containment chamber.

In one exemplary embodiment, the ratio between the diameter of the primary pipe and the diameter of the containment pipe is in the range of about 1:4 to about 1:6. With any of the aforementioned exemplary embodiments, the containment pipe may extend within a single wall sump or may not extend within a sump at all.

### BRIEF DESCRIPTION OF THE DRAWING

FIG. 1 is a partial cross-sectional view of an exemplary embodiment containment system providing under dispenser containment to grade.

FIG. 2 is a partial cross-sectional view of another exemplary embodiment containment system providing under dispenser containment to grade including a termination ring.

### DESCRIPTION OF EXEMPLARY EMBODIMENTS OF THE INVENTION

The exemplary embodiment system disclosed herein is intended to eliminate the need for sumps under fuel dispensers and provide under dispenser containment to grade by enhancing the function of the piping system providing fuel to the dispensers by having it extend to grade. With exemplary embodiment, electrical conduit is routed directly to a dispenser 8, independent of the piping system. By eliminating the UDC sump (thus becoming a “sumpless system”) and the associated penetration fittings, the cost to install an underground piping system will be reduced, its reliability improved and the need for maintenance and repair reduced significantly.

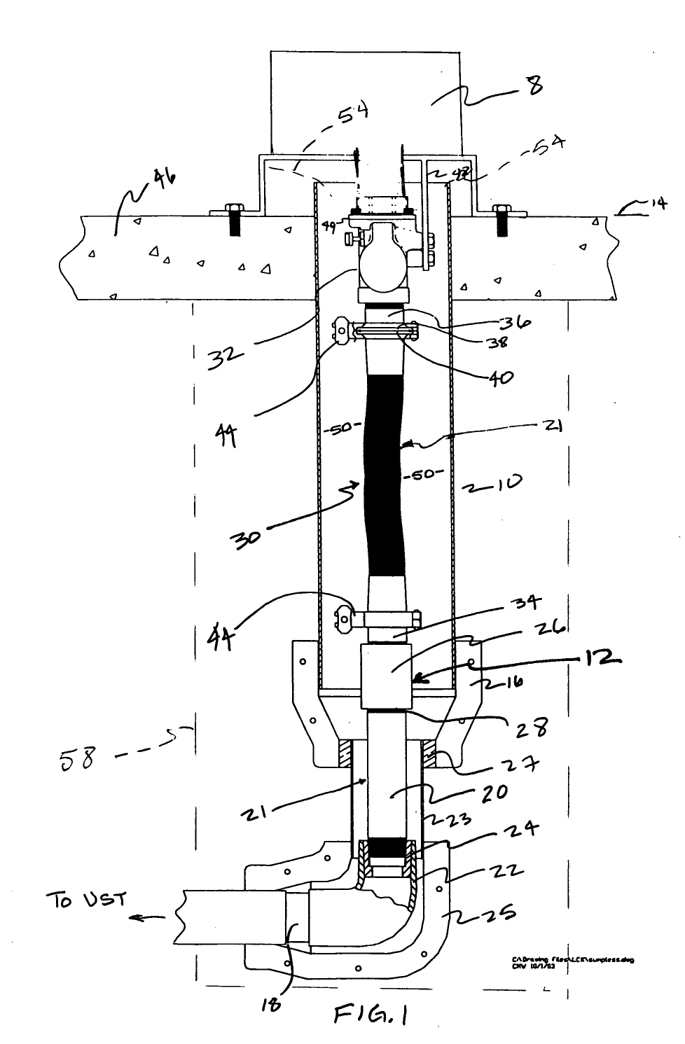

An exemplary embodiment system provides a larger diameter containment pipe 10 from a main run 12 of a fuel piping (i.e., a primary pipe system) 21 to the grade level 14. This is accomplished by using a containment fitting 16 which is a reducing fitting 16 functioning in reverse as an expansion fitting in a direction from the fuel line level toward grade, as for example shown in FIG. 1. In the exemplary embodiment, the containment pipe 10 is made from fiberglass and has a diameter of about 6-8 inches and a thickness of about 1/8 inch.

In the exemplary embodiment shown in FIG. 1, a 2-inch trunk line 18 forms a primary pipe coming from the UST. The trunk line 18 is coupled to a 1½-inch riser pipe 20 by a primary fiberglass fitting 22. In the exemplary embodiment, the trunk line is made from fiberglass and has a thickness of about 0.06-0.08 inch. The fuel carrying pipes (i.e., the fuel piping) or primary pipes define a primary pipe system 21.

In an exemplary embodiment, the primary pipe system 21 includes the riser pipe 20 as shown in the exemplary embodiment in FIG. 1 which threads on one side to the 2-inch fiberglass primary fitting 22 via a reducer threaded bushing 24 bonded inside the fiberglass primary fitting, and on another side to another fitting 26 via a 1½-inch threads 26. In the shown exemplary embodiment, the riser pipe is made of galvanized steel. The riser pipe 20 extends within a secondary riser pipe 23 which is coupled to a secondary fitting 25 which surrounds the primary fitting 22. The secondary riser pipe, in the exemplary embodiment shown in FIG. 1, is made from fiberglass and has a diameter of about 3 inches an a thickness of in the range of about 0.06-0.08 inch.

The containment fitting 16 is coupled to the secondary riser pipe 23. In the exemplary embodiment, a spacer such as a fiberglass spacer 27 is sandwiched between the inner surface of the containment fitting and the outer surface of the secondary riser pipe such that the level of reduction provided by the containment fitting is reduced. In the exemplary embodiment, the containment fitting 16 is bonded to the containment pipe 10 and to the spacer 27. The spacer 27 is bonded to the secondary riser pipe 23.

A flexible connector 30, e.g., a flexible pipe connector, is incorporated as part of the primary pipe system 21 and is coupled to a shear valve 32 extending to grade level. In the exemplary embodiment, a first pipe section 34 is threaded on to fitting 26 opposite the riser pipe 20. A second pipe section 36 is threaded to the shear valve 32. Each pipe section has an annular lip surface 38 as best shown in relation to the second pipe section 36 that mates with a corresponding lip surface 40 of the flexible connector. Clamps 44 are used to urge the pipe sections' annular lip surfaces against corresponding flexible connector lip surfaces 40 for easily coupling and decoupling the flexible connector with the primary pipe system allowing among other things for repairs and maintenance. Seals (not shown) such as annular seals may be interposed between the annular lip surfaces of the pipe sections and the corresponding lip surfaces of the flexible connector. Use of a flexible connector instead of rigid piping is optional allowing for ease of assembly and alignment of the system. An exemplary flexible connector may be 12 inches long and have a diameter of about 1 and 1/2 inches.

The shear valve 32 is securely connected to a concrete island 46 or surface paving concrete on which is mounted the fuel dispenser to allow for proper function. This connection can be made with a bracket 48, as shown, to “reach over” the containment pipe to allow it to rise at least to the grade level. The shear valve break-away plane 49 is installed at grade level and the containment pipe 10 extends at or above grade level. In this regard, if the dispenser or any portion of the primary pipe above the break-away plane is moved, as for example by a vehicle crashing on the dispenser, the shear valve will allow for shearing along the break-away plane and will shut off the fuel from the primary pipe system at the break away plane. The shear valve bracket can connect to standard frame assembly hardware to effect the rigid connection. The upper edge of the frame assembly may be above the grade level (approximately 1 inch under normal practice) in order to prevent rain water from entering the containment pipe.

The overall containment piping which comprises the containment pipes and secondary fittings, in the exemplary embodiment, increases in diameter from about 3 inches (at the secondary riser 23), to about 6 to 8 inches (at the containment pipe 10), to allow reasonable access to the primary piping components within the containment pipe 10. In an exemplary embodiment, the ratio of the diameter of the flexible connector to the diameter of outer containment pipe is in the range of about 1:4 to about 1:6.

By increasing the length of the riser pipe 20 and of the secondary riser pipe 23, the location of the flexible connector and the containment pipe 10 is elevated to provide for easy access to the flexible connector and to the containment chamber 50 from grade. Since the primary pipe system is completely contained by a non-metallic, e.g., fiberglass, secondary or containment system, no cathodic protection is needed for the primary system, as the primary system is not in contact with the soil and as such there is no metal to soil contact.

Above the shear valve, a drip pan 54 may be placed to channel any leakage from dispenser components into the containment chamber 50 formed between the flexible connector 30 and the containment pipe 10. Because of the variety of configurations for various dispensers, the drip pan may be pre-fabricated or fabricated in the field to fit the particular footprint and pipe connection locations specific to the dispenser. The pan may be made with holes directing all fluid into the containment chamber. In an exemplary embodiment, the holes in the pan should be fully surrounded by the containment pipe 10. The drip pan may be sheet of material configured to guide any leakage from the dispenser to the containment chamber 50.

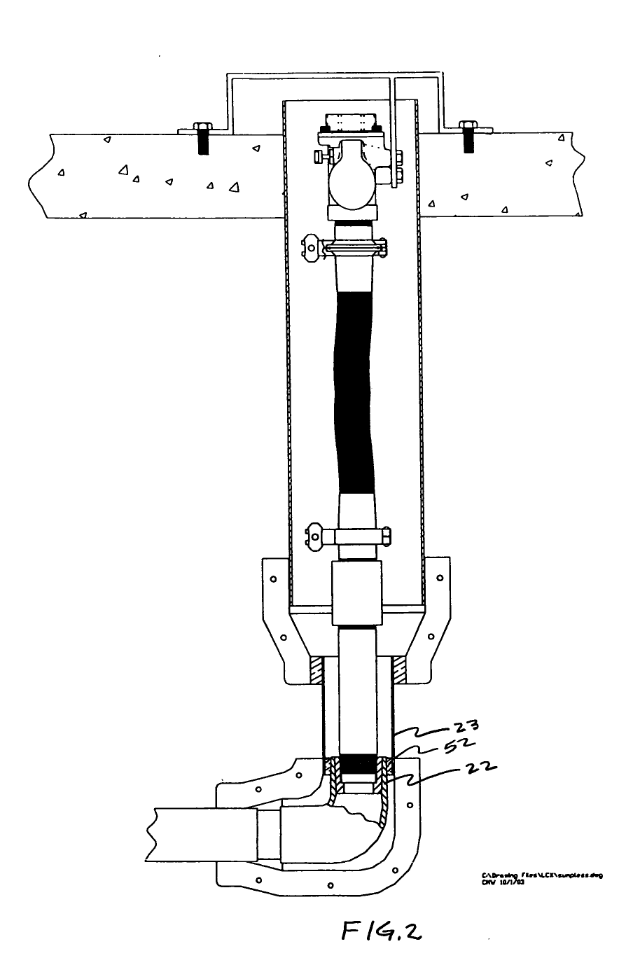

In another exemplary embodiment, a termination ring 52 may be sandwiched between the outer surface of the primary fitting 22 and the inner surface of the secondary riser pipe 23, as for example shown in FIG. 2. In an exemplary embodiment, the termination ring is made from fiberglass and is bonded to the primary fitting and the secondary riser pipe. The termination ring closes the containment causing any leakage from the dispenser to accumulate locally above the termination ring. With this exemplary embodiment, a liquid sensor may be placed over the termination ring for monitoring leakage. Moreover, with this embodiment, an optional test valve (not shown) can be placed below the termination ring to allow testing of the system below the termination ring. The test valve may also provide a monitoring point for the containment pipe for use in jurisdictions such as California where monitoring of the containment piping is required. For example, the system below the termination ring can be tested for water that will collect if the integrity of the secondary pipes is compromised.

If a termination ring is not incorporated, a liquid sensor may be placed in a tank sump (not shown), since all liquid coming into the chamber will drain in such sump. Regulations require the pipe system to slope to the tank from all dispensers to allow both the primary and containment systems to empty completely in case of an emergency situation, such as a fire within the sump.

The inventive system satisfies the containment requirements for all locations. California will require monitoring of the containment system to grade and that the containment system be both liquid tight and vapor tight to grade in relation to the surrounding environment. The exemplary embodiment inventive system provides vapor-tight containment to grade, as defined by California regulations. Vapors can not penetrate the inventive system containment piping below grade level. For example vapors in the soil or in the system cannot penetrate the inventive system containment piping below grade level. Moreover, the inventive system can be used in lieu of double walled sumps that may be necessary for satisfying monitoring requirements. The inventive system may be used as-is, or in alternate exemplary embodiments may be contained within a single-wall UDC sump.

Implementation of the inventive system significantly reduces the cost of installation and greatly reduces the maintenance of the system. By eliminating the a sump and its penetrations which provide the greatest frequency of repair incidence, the present invention provides for an under dispenser containment of higher integrity than conventional sumps with a lower probability of failure.

Moreover the inventive systems provide for less hazardous fluid that needs to be disposed of after testing of the system. One way that sumps are tested is by filling them with water. After testing the water is deemed hazardous and it must be removed and disposed of. With the present invention the amount of hazardous water that will need to be removed and disposed of after testing will be a lot less since the volume of the 6-8 inch containment pipe is a lot less than the volume of a sump having sides longer than 20 inches.

It should be noted that the inventive system has been described herein by way of exemplary embodiments. Although some of the fittings and couplings and pipes have been described as having male or female ends or as being threaded or bonded to another structure, it should be understood that a change form a male to a female end and vice-versa or a change from bonding to threading or to other forms of fastening or from threading to bonding or to other forms of fastening is also within the scope of the present invention. It should be also noted that all pipe diameters provided in the exemplary embodiments herein are nominal outer diameters and comply with the Iron Pipe Size Outside Diameter (IPSOD) convention. Moreover, the thickness of all pipes described in the exemplary embodiments herein are chosen so that the pipes comply with Underwriters Laboratories, Inc. (UL) performance requirements.

Although specific exemplary embodiments are disclosed herein, it is expected that persons skilled in the art can and will design or derive alternative containment systems that are within the scope of the following claims either literally or under the doctrine of equivalents.

1. A containment system comprising:
a primary pipe providing fuel to a fuel dispenser extending above ground grade level, the primary pipe extending subterraneally; and
a containment pipe surrounding the primary pipe defining a containment chamber there between, the containment pipe extending above ground grade level and subterraneally.

2. A system as recited in claim 1 further comprising a shear valve coupled to the primary pipe.

3. A system as recited in claim 2 wherein the shear valve comprises a break away plane at said ground grade level.

4. A system as recited in claim 3 further comprising a bracket coupled to the ground, wherein said shear valve is connected to said bracket.

5. A system as recited in claim 2 further comprising:
a first pipe section having a lip surface; and
a second pipe section having a lip surface, wherein the primary pipe comprises an lip surface at a first end mated with the lip surface of the first pipe section and a lip surface at a second end mated with the lip surface of the second section.

6. A system as recited in claim 4 further comprising:
a first clamp clamping the lip surface of the first pipe section with the primary pipe first end lip surface; and
a second clamp clamping the lip surface of the second pipe section with the primary pipe second end lip surface.

7. A system as recited in claim 1 wherein the primary pipe is flexible.

8. A system as recited in claim 1 wherein the primary pipe comprises a first end over a second end, the system further comprising:
a primary riser pipe axially coupled to the primary pipe second end; and
a secondary riser pipe surrounding the primary pipe and coupled to the containment pipe defining a riser containment space there between, said riser containment space being in communication with said containment chamber defined between the primary pipe and the containment pipe.

9. A system as recited in claim 8 wherein the secondary riser pipe comprises a diameter, wherein the diameter of the containment pipe is greater than the diameter secondary riser pipe, wherein the system further comprises a containment fitting coupled at one end to the containment pipe and at another end to the secondary riser pipe.

10. A system as recited in claim 9 further comprising a spacer coupled to an outer surface of the secondary riser pipe and an inner surface of the containment fitting.

11. A system as recited in claim 8 further comprising:
a primary fitting coupled to the primary riser pipe; and
a secondary fitting coupled to the secondary riser pipe, wherein a fitting annular space is defined between the fittings in communication with the riser containment space.

12. A system as recited in claim 11 further comprising a further pipe section coupled to the primary fitting and to an underground storage tank, wherein the secondary fitting is coupled to an outer surface of said further pipe section.

13. A system as recited in claim 11 further comprising a ring blocking the communication between the fitting annular space and the riser containment space.

14. A system as recited in claim 13 wherein the ring is sandwiched between the secondary riser pipe and the secondary fitting.

15. A system as recited in claim 13 further comprising a liquid sensor in the riser containment space and between the ring and the containment pipe.

16. A system as recited in claim 1 wherein the containment pipe is made from a non-metallic material.

17. A system as recited in claim 1 further comprising a drip pan extending beyond the containment pipe, wherein leakage from the dispenser is guided by the drip pan to the containment chamber.

18. A system as recited in claim 1 wherein the ratio between a diameter of the primary pipe and the a diameter of the containment pipe is in the range of about 1:4 to about 1:6.

19. A system as recited in claim 1 wherein the containment pipe extends within a single wall sump.

20. A system as recited in claim 1 wherein the containment pipe does not extend within a sump.

21. A system as recited in claim 1 wherein the containment pipe comprises a wall that is not penetrated by a conduit.

22. A containment system comprising:
a flexible primary pipe providing fuel to a fuel dispenser extending above ground grade level, the primary pipe extending subterraneally, the primary pipe having a first end over a second end;
a containment pipe surrounding the primary pipe defining a containment chamber there between, the containment pipe extending above ground grade level and subterraneally;
a shear valve coupled to the primary pipe;
a primary riser pipe axially coupled to the primary pipe second end;
a secondary riser pipe surrounding the primary pipe defining a riser containment space there between being in communication with said containment chamber;
a containment fitting coupled at one end to the containment pipe and at another end to the secondary riser pipe, wherein the secondary riser pipe comprises a diameter, wherein the diameter of the containment pipe is greater than the diameter secondary riser pipe;
a primary fitting coupled to the primary riser pipe; and
a secondary fitting coupled to the secondary riser pipe, wherein a fitting annular space is defined between the fittings in communication with the riser containment space.

23. A system as recited in claim 22 further comprising a ring blocking the communication between the annular space defined between the primary and secondary fittings and the annular space defined between the primary and secondary riser pipes.
